(19) United States
(12) Patent Application Publication
(10) Pub. No.: US 2014/0016664 A1
(43) Pub. Date: Jan. 16, 2014

(54) METHOD FOR MEASURING THE THERMAL CONDUCTIVITY OF AN ANISOTROPIC THIN MATERIAL

(71) Applicant: Commissariat a I'energie atomique et aux energies alternatives, Paris (FR)

(72) Inventors: Joel Pauchet, Saint Martin D'uriage (FR); Ludovic Rouillon, Villard de Lans (FR)

(21) Appl. No.: 13/940,866

(22) Filed: Jul. 12, 2013

(30) Foreign Application Priority Data
Jul. 13, 2012 (FR) 1256787

(51) Int. Cl. G01N 25/18

(52) U.S. Cl. CPC G01N 25/18
USPC 374/44

(57) ABSTRACT

A method for measuring the thermal conductivity along three directions of an anisotropic thin material includes: positioning on the surface of the material a plurality N of sensors able to measure the temperature of the material at N measuring points; generating a heat flux from a heat source positioned on a surface of the material; determining a mapping of the theoretical temperature of the material at the N measuring points of the N sensors along three directions by using a calculator, determining a mapping of the real temperature on the surface of the anisotropic material by measuring the temperature of the material at the N measuring points of N sensors; determining using the calculator the real thermal conductivity of the thin anisotropic material, along three directions, by a plurality of adjustments of the theoretical thermal conductivity by minimising the difference between the theoretical temperature and the real temperature for each of the N temperature measuring points.

The present invention relates to a method for measuring the thermal conductivity of an anisotropic thin material.

The invention applies particularly to the measurement of the thermal conductivity of electrodes constituting the cell of fuel cells or electrolysers which are formed by anisotropic materials of low thickness.

In a known manner, the cells, also known as elementary assemblies, of fuel cells, such as PEMFC (Proton Exchange Membrane Fuel Cell) are composed of a membrane made of ion conducting polymer (protonic for PEMFC), also known as electrolyte, and two porous electrodes (anode and cathode) surrounding the electrolyte.

The electrodes are constituted of a first zone of electrochemical reactions, known as active zone, situated in contact with the electrolyte and a second zone, known as diffusion zone, making it possible to evacuate the water vapour produced and making it possible to homogenise the diffusion of the reactive gases.

On either side of the elementary assembly, distributing plates, also known as bipolar plates, formed by the alternation of teeth and channels, enable the supply of hydrogen to the anode, air to the cathode as well as the evacuation of the water produced. They also enable the recovery of electrons from the oxidation reaction at the anode.

The ionic transfer of the membrane is directly correlated to its water content. The necessity of maintaining a satisfactory hydration state of the membrane makes the management of water a key element in the functioning of this type of fuel cell.

The water produced by the electrochemical reaction is evacuated to the distribution channels of the bipolar plates while passing through the active layer and the diffusion layer of the electrode. In these different layers, the water produced will be in vapour or liquid form as a function of the local temperature levels within the different elements of the fuel cell. Thus, the elementary assembly being hotter than the distributions channels, the risk of condensation of water in the active layers and the diffusion layers is all the greater the less heat conducting are the layers.

The presence of condensation in the layers has the effect of increasing the amount of liquid water in the elementary assembly thereby reducing the access of the gases by a phenomenon known as “flooding” and thus the performances of the fuel cell.

The active layers and the diffusion layers are thin layers of anisotropic materials (typically from 5 to 30 μm thickness for the active layer and from 100 to 500 μm thickness for the diffusion layer) and deformable. Their thermal conductivity properties depend on their state of compression in the elementary assembly and thus on the mechanical tightening of the cells and the local presence of a channel or of a tooth in contact with the layers.

Given the stacking architecture of a fuel cell, heat transfers take place either in the thickness of the components (from the active layer to the channel) or in the plane of the components at the teeth present between each channel.

It thus appears important to be able to determine the thermal conductivity of the materials used for the formation of the active and diffusion layers.

Numerous methods for measuring thermal conductivity are known, such as for example the measurement method by the application of a hot plate to the end of the sample creating a thermal gradient over the length of the sample. However, this method makes it possible to determine the thermal conductivity along one direction and thus consequently the longitudinal and optionally transversal thermal conductivity by the bias of a second test on a different sample or instead by dismantling then reassembling the same sample.

This type of method is difficult to apply to deformable anisotropic materials and not adapted to the thin layers which are the active layers and the diffusion layers of fuel cells, the thermal properties of which depend on the crushing of the material. In fact, the measurement conditions (i.e. tightening, shape of the sample, etc.) between two series of measurements are not reproducible following the manipulation of the sample. The measurement conditions are also difficult to reproduce between two separate samples.

Patent application JP2005/214858 discloses a method for measuring a thermal conductivity in the plane of an anisotropic sample. Nevertheless, this measurement method does not make it possible to measure in a single operation (i.e. without manipulation of the sample) the longitudinal and transversal thermal conductivity of an anisotropic sample.

Thus, the invention aims to propose a method for measuring thermal conductivity making it possible to determine, in a single experimental operation and on a same sample, the longitudinal and transversal conductivity of an anisotropic sample of low thickness, typically of a thickness varying between several micrometres (μm) and several hundred μm.

To this end, the invention proposes a method for measuring the thermal conductivity along three directions of an anisotropic thin material comprising the steps consisting in;
positioning on the surface of the material a plurality N of sensors able to measure the temperature of said material at N measuring points;
generating a heat flux φ from a heat source positioned on a surface of said material;
determining a mapping of the theoretical temperature of the material at the measuring points of the N sensors along three directions (x, y, z) by means of a calculator (400);
determining a mapping of the real temperature on the surface of said anisotropic material by measurement of the temperature of the material at the N measuring points of the N sensors;
determining by means of said calculator the real thermal conductivity (λₓ, λ_{y}, λ_{z}) of said thin anisotropic material, along three directions, by a plurality K of adjustments of said theoretical thermal conductivity by minimising the difference between the theoretical temperature and the real temperature for each of the N temperature measuring points.

The method according to the invention thus makes it possible to determine, with a controllable and quantifiable precision, the thermal conductivities along three directions (transversal thermal conductivity, longitudinal thermal conductivity and thermal conductivity in the thickness) in a single experimental operation, on a same sample and without manipulation (assembly, dismantling) of said sample. Such a method thus makes it possible to analyse anisotropic samples of low thickness without dismantling, which is essential to characterise electrodes constituting the cell of fuel cells or electrolysers.

The method according to the invention may also have one or more of the characteristics below, considered individually or according to any of the technically possible combinations thereof:
said theoretical thermal conductivity is adjusted as long as the calculated real thermal conductivity (λₓ, λ_{y}, λ_{z}) does not vary by more than 10⁻⁴ between two successive adjustments;
said mapping of the theoretical temperature is determined from:
   the ambient temperature;
   the heat flux generated by said heat source;
   the theoretical thermal conductivity of the anisotropic material;
   the geometry of the heat source;
the method comprises a step of tightening said anisotropic material in a tightening tool so as to compress said material into a given state;
said heat source is formed by a micro-wire extending at least on a part of said material;
said N sensors are formed by micro-wires extending at least on a part of said material;
said sensors are positioned on the upper face and the lower face of said material;
said sensors are positioned on two faces of said material;
said step of positioning the N sensors is carried out by means of a positioning tool making it possible to know with a precision less than ten micrometres, the relative position of the different sensors with respect to said heat source;
said anisotropic thin material is an electrochemical cell of a fuel cell.

The subject matter of the invention is also a positioning tool for the implementation of the method for measuring thermal conductivity according to the invention characterised in that it comprises:
a first comb having a plurality N+1 of grooves;
a second comb having a plurality N+1 of grooves;
   the first and the second combs being laid out so that the grooves of the first comb are opposite the grooves of the second comb, said N+1 grooves of the combs being able to receive said N sensors and said heat source.

Advantageously, the tool comprises means able to maintain under tension said sensors and said heat source.

Other characteristics and advantages of the invention will become clear from the description that is given thereof below, by way of indication and in no way limiting, with reference to the appended figures, among which:

FIG. 1 illustrates a diagram of an example of operating mode of the method for measuring the thermal conductivity of an anisotropic thin material according to the invention;

FIG. 2 illustrates a synoptic diagram presenting the main steps of the fine control method according to the invention;

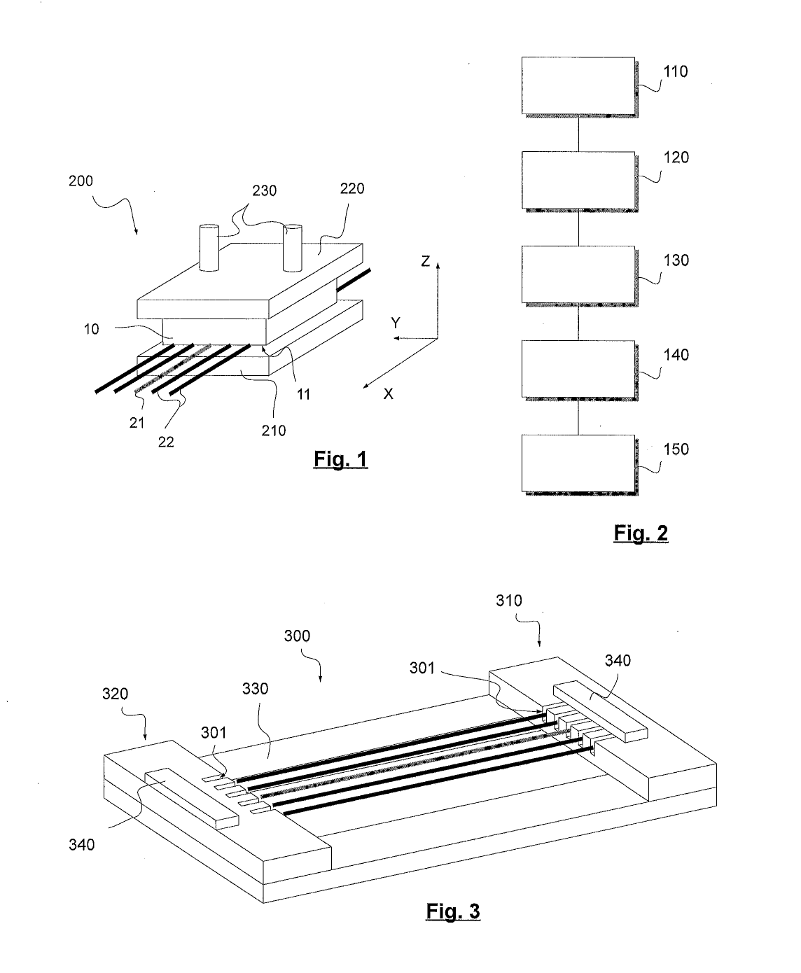

FIG. 3 represents a positioning device enabling the implementation of the measurement method according to the invention;

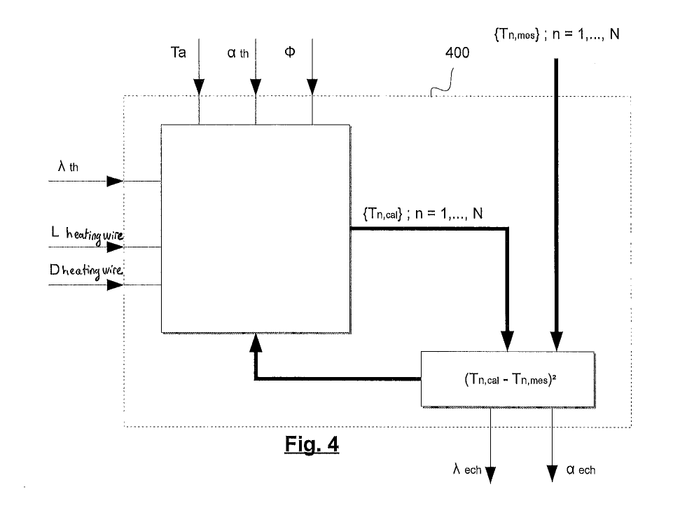

FIG. 4 represents a diagram presenting the main calculation steps enabling the determination of the thermal conductivity of an anisotropic thin material to be characterised.

### DESCRIPTION OF AT LEAST ONE EMBODIMENT

In all the figures, common elements bear the same reference numbers.

FIG. 1 illustrates an example of operating mode of the method for measuring the thermal conductivity of an anisotropic material 10 presented in the form of a sample.

The first step 110 of the method 100, the block diagram of which is illustrated in FIG. 2, consists in positioning a plurality of wires 21, 22 in contact with the sample 10 to be characterised. The wires have a diameter of the order of a micron or ten or so microns.

In the embodiment example illustrated in FIG. 1, a first wire 21 is used as a heat source generating a heat flux φ on the surface 11 of the sample 10. The heat flux φ spreads out over the surface of the sample (along the directions X and Y) as well as in its thickness (along the direction Z).

The other micro-wires, represented by the reference 22, (seven wires 22 being represented as an example) positioned around the heating wire 21 and on the upper face are used as sensors to measure the temperature on the surface of the sample 10. To this end, each measuring wire 22 has a measuring point shrewdly positioned as a function of the sample to be characterised, so as to carry out the most representative mapping of the temperature on the surface of the sample.

The measuring wires 22 are positioned at the periphery of the sample 10 (advantageously on the upper face and on the lower face of the sample 10, as represented in FIG. 1), the positioning of the measuring wires 22 being determined as a function of the number of characteristics of the material to determine as well as the desired precision.

The heating wire 21 is extended at least over a large part of the sample 10 to be characterised, and advantageously over the whole length of the sample 10, so as to create a stationary heat flux over a large part of the sample 10 (i.e. at least over two thirds of its length).

The number and the positioning of the measuring wires 22 depends on the type and the number of characteristics that it is wished to determine. Thus, thanks to the invention, it is possible to determine, in a single experimental manipulation, the longitudinal thermal conductivity (along the X axis), the transversal thermal conductivity (along the Y axis) as well as the thermal conductivity in the thickness of the material (along the Z axis).

This first step of positioning 110 the micro-wires 21 and 22 is very important because the precise knowledge of the relative positions of the micro-wires 22 with respect to the heating wire 21 makes it possible to improve significantly the precision during the step of calculating the thermal conductivities of the material, which will be detailed hereafter.

A first operating mode of this step of positioning 110 is illustrated in FIG. 3. In this operating mode, a tool 300 formed by two combs 310, 320 each having a plurality of grooves 301 is used. The two combs 310, 320 are arranged solidarily on either side of a rigid frame 330. The combs 310, 320 are positioned so that the grooves 301 of a first comb are located opposite and aligned with the grooves 301 of the second comb 320.

These two combs 310, 320 may be formed by etching on silicon plates so as to create the patterns of the grooves. The grooves 301 are typically of a width of 50 micrometres and a depth of 50 micrometres and are spaced apart by a distance varying from twenty or so micrometres to several hundreds of micrometres.

Each micro-wire 21 and 22 is inserted into one of the grooves 301 of the combs 310, 210 and drawn tight between said two combs 310, 320 by means 340 provided for said purpose. Thus, the relative positioning of the micro-wires 21, 22 is known in a precise manner with a precision less than 10 micrometres.

According to a second operating mode of positioning measuring micro-wires 22 (not represented), the micro-wires 22 are positioned on a measurement plate. This measurement plate is then used as support to receive the sample.

In the example of embodiment of the invention illustrated in FIG. 1 consisting in determining the thermal conductivity along three directions, such as the longitudinal thermal conductivity λₓ, in the longitudinal direction X, the transversal thermal conductivity λ_{y}, in the transversal direction Y, and the thermal conductivity in the thickness λ_{z} in the direction of the thickness Z, the measuring wires 22 are positioned on the lower face 11 and on the upper face 12 of the sample 10.

Whatever the operating mode of positioning the measuring micro-wires 22 used, the sample 10 and the micro-wires 21, 22 positioned on the surface of the sample 10, are inserted into a tightening tool 200 during a second step 120.

The tightening tool 200 comprises a lower plate 210 and an upper plate 220 which are situated on either side of the sample 10. The two plates 210 and 220 cooperate with tightening means 230 able to compress the sample 10 into a given compression state. The tightening plates 210, 220 are advantageously two to three times bigger than the sample 10.

Thus, the tightening tool 200 makes it possible to simulate the real conditions of use of the anisotropic material and thus to measure the real thermal conductivities during the use of the thin anisotropic material. For example such an anisotropic material may be used as electrolytic membrane in an elementary assembly of a fuel cell. To simulate such an application, the lower plate 210 and the upper plate 220 form the anode and the cathode positioned on either side of the electrolytic membrane.

In the second operating mode of positioning the micro-wires presented previously, the measuring plates used for the positioning of the wires are also used to form the tightening plates 210, 220 of the tool 200. The sample 10 is thus placed on said plates on which the micro-wires 21, 22 are positioned.

The plates 210, 220 are for example made of polymers, advantageously polyimides (imide based polymer).

The third step 130 of the method 100 according to the invention, illustrated in FIG. 4, consists in calculating, by means of a calculator comprising a numerical model 400, the N theoretical temperatures (T_{n,calc} with n−1, . . . N) on the surface of the sample 10 at the N measuring points of the N measuring wires 22 positioned during previous steps. This third calculation step 130 makes it possible to carry out a theoretical thermal mapping of the sample 10 as a function of the heat flux φ generated by the heating wire 21 and from theoretical input data.

To do this, the numerical model 400 receives in input the following data:
the measured ambient temperature Ta (° C.);
the exchange coefficient α (W/m²·° C.) between the surface of the heating wire 21 and the ambient air;
the heat flux φ (W) generated by the heating wire 21;
at least two theoretical components of the tensor of thermal conductivities of the material λ (λₓ, λ_{y}, λ_{z}) (W/m·° C.).

The numerical model makes it possible, from the aforementioned input data as well as data relative to the geometry of the heating wire 21, such as the length of the wire and the diameter of the wire, to determine through the use of Fourier's law, the N temperatures T_{n,calc}, with n=1, . . . N, at the N measuring points of the N measuring wires 22.

In a fourth step 140 of the method, the N calculated temperatures T_{calc} are compared with the N measured temperatures Tₘₑₛᵤ.

The fifth step 150 of the method consists in identifying the real thermal conductivities of the sample 10 by means of the numerical model 30 in such a way as to modify the parameters of the model so that for each measured temperature, the difference between the calculated temperature and the measured temperature, for a given point n, tends towards 0, i.e.: (T_{n,calc}−T_{n,mesu})²→0, with n=1, . . . , N.

To do this, several iterations k (k=1, . . . , K) are carried out with different sets of parameters to identify. In the embodiment example, the set of parameters to identify Pₖ represents: pₖ=(λₓ, λ_{y}, λ_{y}, α).

For each of the iterations k, the N calculated temperatures are compared with the N measured temperatures. Thus, through the application of a minimisation procedure according to the following function:

$$S ( P ) = {\sum }_{n = 1}^{n = N} {〚 {( T 〛}_{n , Calc , k} P ( k ) - {T}_{n , mesu , k} )}^{2} ,$$

the optimal values of the parameters P are determined, via methods dedicated to this purpose.

Advantageously, the calculation iterations are stopped as soon as the thermal conductivities calculated between two successive iterations do not vary by more than 10⁻⁴.

The precise positioning of these sensors thanks to the use of combs 310, 320 makes it possible to increase the precision of determining thermal conductivities. In the same way, the multiplication of the sensors also makes it possible to increase the calculation precision. Thus, it is possible to modify the number of sensors as a function of the desired precision so as to obtain a cost/precision ratio optimised to each application.

It will be noted that it is also possible to carry out tests by generating different heat fluxes, so as to modify the temperature differences between the different sensors and thereby minimise the uncertainties relative to the sensors.

The method according to the invention thus makes it possible to determine thermal conductivities along three directions while taking into account thermal losses with an important precision, the basic equations of the numerical model not being simplified. Thanks to the method according to the invention:
the relative uncertainty of the positioning of the sensors is less than ±10 micrometres (μm) for measuring wires spaced apart by 100 μm;
the uncertainty regarding the measurement of the temperature is of the order of ±0.1° C.

Thus, as an example, by using six measuring wires on the lower face of the sample, on either side of the heating wire, and a measuring wire on the upper face of the sample, the method makes it possible to obtain a longitudinal and transversal thermal conductivity with a relative error of the order of 30% and a thermal conductivity in the thickness of the material with an error less than 10%.

According to the example illustrated in FIG. 1, by using four measuring wires on the lower face 11 of the sample, on either side of the heating wire, and three measuring wires on the upper face 12 of the sample, the method according to the invention makes it possible to obtain a longitudinal and transversal thermal conductivity with a relative error of the order of 50% and a thermal conductivity in the thickness of the material with a relative error of the order of 5%.

According to another embodiment of the invention, it is possible to do without the determination of the exchange coefficient α, likely to be inhomogeneous according to the geometry and the environment of the sensor, by carrying out tests in transitory regime. In other words, the principle is to generate a heat flux for a short time and to measure the temperatures before the exterior part of the sensor (i.e. the part not in contact with the sample) begins to rise in temperature.

The other advantages of the invention are notably the following:
reproducibility of the measurement conditions (tightening, shape of the sample, etc.);
possibility of carrying out several tightening stresses without dismantling the sample;
determination of the thermal conductivity of a material along three dimensions in a single measurement;
finely controlling the position of the sensors making it possible to increase the precision of the thermal conductivities.

1. Method for measuring the thermal conductivity along three directions of an anisotropic thin material comprising:
positioning on a surface of the material a plurality N of sensors able to measure the temperature of said material at N measuring points;
generating a heat flux from a heat source positioned on a surface of said material;
determining a mapping of a theoretical temperature of the material at the N measuring points of the N sensors along three directions by using a calculator;
determining a mapping of a real temperature on the surface of said anisotropic material by measuring the temperature of the material at the N measuring points of the N sensors (22);
determining using said calculator the real thermal conductivity of said thin anisotropic material, along three directions, by a plurality K of adjustments of said theoretical thermal conductivity by minimising the difference between the theoretical temperature and the real temperature for each of the N temperature measuring points.

2. The method for measuring the thermal conductivity along three directions of an anisotropic thin material according to claim 1, wherein said theoretical thermal conductivity is adjusted as long as the calculated real thermal conductivity does not vary by more than 10⁻⁴ between two successive adjustments.

3. The method for measuring the thermal conductivity along three directions of an anisotropic thin material according to claim 1, wherein said mapping of the theoretical temperature is determined from:
the ambient temperature,
the heat flux generated by said heat source,
the theoretical thermal conductivity of the anisotropic material;
the geometry of the heat source.

4. The method for measuring the thermal conductivity along three directions of an anisotropic thin material according to claim 1, comprising tightening said anisotropic material in a tightening tool so as to compress said material into a given state.

5. The method for measuring the thermal conductivity along three directions of an anisotropic thin material according to claim 1, wherein said heat source is formed by a micro-wire extending at least on a part of said material.

6. The method for measuring the thermal conductivity along three directions of an anisotropic thin material according to claim 1, wherein said N sensors are formed by micro-wires extending at least on a part of said material.

7. Method The method for measuring the thermal conductivity along three directions of an anisotropic thin material according to claim 1, wherein said sensors are positioned on the upper face and the lower face of said material.

8. Method The method for measuring the thermal conductivity along three directions of an anisotropic thin material according to claim 1, wherein said positioning N sensors is carried out using a positioning tool making it possible to know, with a precision of less than ten micrometres, the relative position of the different sensors with respect to said heat source.

9. The method for measuring the thermal conductivity along three directions of an anisotropic thin material according to claim 1, wherein said anisotropic thin material is an electrochemical cell of a fuel cell.

10. Positioning tool for the implementation of the method for measuring thermal conductivity according to claim 1 comprising:
a first comb having a plurality N+1 of grooves;
a second comb having a plurality N+1 of grooves;
the first and the second combs being laid out so that said grooves of the first comb are opposite the grooves of the second comb, said N+1 grooves of the combs being able to receive said N sensors and said heat source.

11. The positioning tool for the implementation of the method for measuring thermal conductivity according to claim 10, comprising means able to maintain under tension said sensors and said heat source.
